(19) United States
(12) Patent Application Publication
(10) Pub. No.: US 2026/0251321 A1
(43) Pub. Date: Aug. 27, 2026

(54) HUMIDITY CONTROLLING DEVICE AND HUMIDITY CONTROLLING SYSTEM

(71) Applicant: NGK INSULATORS, LTD., Nagoya-shi (JP)

(72) Inventor: Takafumi HAMADA, Nagoya-shi (JP)

(73) Assignee: NGK INSULATORS, LTD., Nagoya-shi (JP)

(21) Appl. No.: 19/538,018

(22) Filed: Feb. 12, 2026

(30) Foreign Application Priority Data
Feb. 27, 2025 (JP) 2025-030572

(51) Int. Cl. F24F 3/14; B01D 46/24; B01D 53/04; B01D 53/047; B01D 53/26

(52) U.S. Cl. CPC F24F 3/1411; B01D 46/247; B01D 46/2482; B01D 53/0454; B01D 53/047; B01D 53/261

(57) ABSTRACT

A humidity controlling device includes a base material portion, and an adsorption portion provided on a surface of the base material portion and containing an adsorbent configured to adsorb and desorb moisture. The adsorbent has an amount of moisture adsorbed Ad₂₀ of 15% by mass or more at a relative humidity of 20% or more, and a difference Ad₈-Ad₁ of 5% by mass or more, the difference being between an amount of moisture adsorbed Ad₈ at a relative humidity of 8% and an amount of moisture adsorbed Ad₁ at a relative humidity of 1%, in a moisture adsorption isotherm.

### CROSS REFERENCE TO RELATED APPLICATIONS

This application claims the benefit of priority to Japanese Patent Application No 2025-030572 filed on Feb. 27, 2025 with the Japanese Patent Office, the entire contents of which are incorporated herein by reference in its entirety.

### FIELD OF THE INVENTION

This disclosure relates to an air humidity controlling device and a humidity controlling system.

### BACKGROUND OF THE INVENTION

In various types of vehicles such as automobiles, there are increasing requirements for improvement of vehicle interior environment. Specific requirements illustrate reduction of an amount of CO₂ in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problems, Patent Literature 1 proposes a heater element comprising: a honeycomb structure having an outer peripheral wall and partition walls disposed on an inner side of the outer peripheral wall, the partition walls defining a plurality of cells each extending from one end face to other end face to form a flow path, at least the partition walls having a material having a PTC (Positive Temperature Coefficient) property; and a pair of electrodes provided on certain positions of the honeycomb structure, wherein the heater element has an adsorbing layer (functional material-containing layer) for adsorbing water vapor (moisture) and the like on surfaces of the partition walls. However, when this humidity controlling device is placed in an air conditioning duct, there is a problem that water vapor and the like can be efficiently adsorbed on the upstream side relative to the direction of air flow, but the adsorption efficiency of water vapor and the like decreases on the downstream side because the humidity in the air decreases.

Also, Patent Literature 2 proposes a vehicle dehumidification device provided with a moisture adsorption device (humidity controlling device) that adsorbs water vapor (moisture) contained in air in a vehicle interior, wherein the moisture adsorption device includes a plurality of adsorption portions having different moisture adsorption characteristics and regeneration temperatures, the moisture adsorption device includes an upstream adsorption portion that is one of adsorption portions arranged on the upstream side in the air flow direction and a downstream adsorption portion that is one of the other adsorption portions arranged on the downstream side in the air flow direction, and the upstream adsorption portion has a moisture adsorption characteristic of adsorbing a larger amount of water vapor than the downstream adsorption portion in a high humidity environment, and the downstream adsorption portion has an adsorption characteristic of adsorbing a larger amount of water vapor than the upstream adsorption portion in a low humidity environment. In this vehicle dehumidification device, the water vapor in the air can be efficiently adsorbed over the entire area of the moisture adsorption device in the high humidity environment, and the absolute humidity of the air in the vehicle interior can be sufficiently reduced by the moisture adsorption function of the downstream adsorption portion in the low humidity environment. However, since the moisture adsorption device used in this vehicle dehumidification device requires the upstream adsorption portion and the downstream adsorption portion to carry different moisture adsorbents with different moisture adsorption performances, the number of parts and the size of the moisture adsorption device increase, and its producing steps become complicated.

As described above, the humidity controlling device of Patent Literature 1 has a problem that the moisture adsorption efficiency decreases because the humidity in the air decreases on the downstream side. Further, the humidity controlling device of Patent Literature 2 has a problem that since it is necessary to provide a plurality of adsorption portions having different moisture absorption performances, the number of parts and the size of the humidity controlling device increase, and its producing steps become complicated.

This disclosure has been made to solve the problems as described above, and an object thereof is to provide a humidity controlling device and a humidity controlling system that can efficiently adsorb moisture in the air regardless of the humidity in the air.

### PRIOR ART

### Patent Literatures

[Patent Literature 1] WO 2023/074202
[Patent Literature 2] Japanese Patent Application Publication No. 2022-80758 A

### SUMMARY OF THE INVENTION

As a result of intensive studies for humidity controlling devices, the inventor has found that, by forming an adsorption portion using an adsorbent in which, in a moisture adsorption isotherm, an amount of moisture adsorbed at a relative humidity of 20% or more, and a difference between an amount of moisture adsorbed at a relative humidity of 8% and an amount of moisture adsorbed at a relative humidity of 1% are within predetermined ranges, the moisture in the air can be efficiently adsorbed regardless of the humidity in the air. That is, this disclosure is exemplified as follows:

<1> A humidity controlling device including:
a base material portion; and
an adsorption portion provided on a surface of the base material portion, the adsorption portion including an adsorbent configured to adsorb and desorb moisture,
wherein the adsorbent has an amount of moisture adsorbed Ad₂₀ of 15% by mass or more at a relative humidity of 20% or more, and a difference Ad₈-Ad₁ of 5% by mass or more, the difference being between an amount of moisture adsorbed Ad₈ at a relative humidity of 8% and an amount of moisture adsorbed Ad₁ at a relative humidity of 1%, in a moisture adsorption isotherm.

<2> The humidity controlling device according to <1>, wherein the amount of moisture adsorbed Ad₂₀ at a relative humidity of 20% or more may be 20% by mass or more in the moisture adsorption isotherm.

<3> The humidity controlling device according to <1>, wherein the amount of moisture adsorbed Ad₂₀ at a relative humidity of 20% or more may be 23% by mass or more in the moisture adsorption isotherm.

<4> The humidity controlling device according to <1>, wherein the amount of moisture adsorbed Ad₂₀ at a relative humidity of 20% or more may be 25% by mass or more in the moisture adsorption isotherm.

<5> The humidity controlling device according to any one of <1> to <4>, wherein the difference Ad₈-Ad₁ between the amount of moisture adsorbed Ad₈ at a relative humidity of 8% and the amount of moisture adsorbed Ad₁ at a relative humidity of 1% may be 8% by mass or more in the moisture adsorption isotherm.

<6> The humidity controlling device according to any one of <1> to <4>, wherein the difference Ad₈-Ad₁ between the amount of moisture adsorbed Ad₈ at a relative humidity of 8% and the amount of moisture adsorbed Ad₁ at a relative humidity of 1% may be 10% by mass or more in the moisture adsorption isotherm.

<7> The humidity controlling device according to any one of <1> to <4>, wherein the difference Ad₈-Ad₁ between the amount of moisture adsorbed Ad₈ at a relative humidity of 8% and the amount of moisture adsorbed Ad₁ at a relative humidity of 1% may be 17% by mass or more in the moisture adsorption isotherm.

<8> The humidity controlling device according to any one of <1> to <7>, wherein the difference Ad₈-Ad₁ between the amount of moisture adsorbed Ad₈ at a relative humidity of 5% and the amount of moisture adsorbed Ad₁ at a relative humidity of 1% may be 5% by mass or more in the moisture adsorption isotherm.

<9> The humidity controlling device according to any one of <1> to <7>, wherein the difference Ad₈-Ad₃ between the amount of moisture adsorbed Ad₈ at a relative humidity of 5% and the amount of moisture adsorbed Ad₃ at a relative humidity of 3% may be 2% by mass or more in the moisture adsorption isotherm.

<10> The humidity controlling device according to any one of <1> to <9>, wherein the adsorbent may be at least one selected from the group consisting of X-type zeolite, Y-type zeolite, A-type zeolite, and MFI-type zeolite.

<11> The humidity controlling device according to any one of <1> to <9>, wherein the adsorbent may be a Y-type zeolite having a SiO₂/Al₂O₃ molar ratio of 10 or less.

<12> The humidity controlling device according to any one of <1> to <11>, wherein the base material portion may be a honeycomb structure having an outer peripheral wall and partition walls provided on an inner side of the outer peripheral wall, the partition walls defining a plurality of cells, each of the cells extending from a first end face to a second end face of the honeycomb structure to form a flow path for air,
and wherein the adsorption portion may be an adsorbing layer provided on a surface of each of the partition walls.

<13> The humidity controlling device according to <12>, which may further include a pair of electrodes provided on the first end face and the second end face of the honeycomb structure, or on the outer peripheral wall parallel to an extending direction of the cells of the honeycomb structure.

<14> The humidity controlling device according to <12> or <13>, wherein at least the partition walls of the honeycomb structure may be made of a material having a PTC property.

<15> A humidity controlling system including:
a flow path through which air can flow;
the humidity controlling device according to any one of <1> to <14> provided in the flow path.

### BRIEF DESCRIPTION OF THE DRAWINGS

FIG. 1 is a schematic cross-sectional view of a humidity controlling device according to an embodiment of this disclosure;

FIG. 2A is a moisture adsorption isotherm of an adsorbent usable in this disclosure;

FIG. 2B is a moisture adsorption isotherm of an adsorbent not usable in this disclosure;

FIG. 3A is a schematic cross-sectional view parallel to a flow direction of a humidity controlling device according to an embodiment of this disclosure which uses a honeycomb structure for a base material portion;

FIG. 3B is a schematic cross-sectional view of the humidity controlling device taken along the line a-a′ in FIG. 3A; and

FIG. 4 is an overall schematic configuration view of a humidity controlling system according to an embodiment of the present disclosure.

### DETAILED DESCRIPTION OF THE INVENTION

The humidity controlling device according to this disclosure includes a base material portion, and an adsorption portion provided on a surface of the base material portion and containing an adsorbent capable of adsorbing and desorbing moisture. The adsorbent has an amount of moisture adsorbed Ad₂₀ of 15% by mass or more at a relative humidity of 20% or more, and a difference Ad₈-Ad₁ of 5% by mass or more, the difference being between an amount of moisture adsorbed Ad₈ at a relative humidity of 8% and an amount of moisture adsorbed Ad₁ at a relative humidity of 1%, in a moisture adsorption isotherm. With such a configuration, the humidity controlling device according to this disclosure can efficiently adsorb moisture in the air regardless of the humidity in the air.

A humidity controlling system according to this disclosure includes a flow path through which air can flow, and the above humidity controlling device provided in the flow path. Since the humidity controlling system according to this disclosure includes the above humidity controlling device, it can efficiently adsorb moisture in the air regardless of the humidity in the air.

Hereinafter, embodiments of the disclosure will be specifically described with reference to the drawings. It should be understood that the disclosure is not limited to the following embodiments, and those which have appropriately added changes, improvements and the like to the following embodiments based on knowledge of a person skilled in the art without departing from the spirit of the disclosure fall within the scope of the disclosure.

As used herein, a numerical range expressed using “to” means a range including numerical values described before and after “to” as a lower limit value and an upper limit value, unless otherwise specified. Further, as used herein, a numerical range where a numerical value is accompanied by “more than” or “less than” means a range that does not include the numerical value as a lower limit or an upper limit.

Regarding the numerical ranges described stepwise as described herein, the upper limit of a certain stepwise numerical range may be replaced with the upper limit of another stepwise numerical range or a value shown in Examples. Also, regarding the numerical ranges described stepwise as described herein, the lower limit of a certain stepwise numerical range may be replaced with the lower limit of another stepwise numerical range or a value shown in Examples.

### (1. Humidity Controlling Device)

The humidity controlling device according to an embodiment of this disclosure can be suitably used for adjusting indoor humidity in various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system according to an embodiment can be suitably used for a vehicle that has no internal combustion engine such as electric vehicles and electric rail cars.

In addition to vehicles, the humidity controlling device according to the embodiment of this disclosure can be used to adjust indoor humidity in buildings such as houses, offices, factories, stores, and warehouses, as well as in transport machinery such as ships and airplanes.

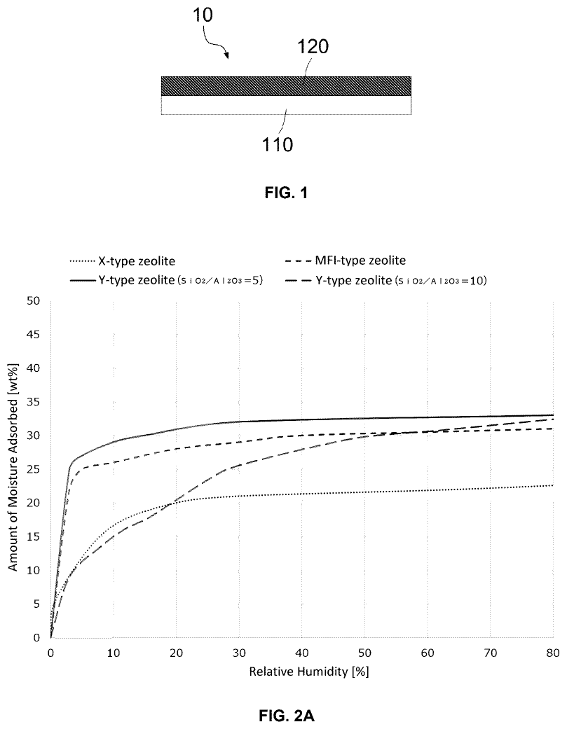

FIG. 1 is a schematic cross-sectional view of a humidity controlling device according to an embodiment of this disclosure.

As illustrated in FIG. 1, a humidity controlling device 10 according to an embodiment of this disclosure includes a base material portion 110 and an adsorption portion 120 provided on a surface of the base material portion 110.

The adsorption portion 120 contains an adsorbent capable of adsorbing and desorbing moisture.

In a moisture adsorption isotherm, the adsorbent has an amount of moisture adsorbed Ad₂₀ at a relative humidity of 20% or more (that is, the entire range where the relative humidity is 20% or more) (hereinafter abbreviated as “moisture adsorption amount Ad₂₀”) of 15% by mass or more, preferably 20% by mass or more, more preferably 23% by mass or more, and even more preferably 25% by mass or more. By controlling the moisture adsorption amount Ad₂₀ within such a range, the moisture adsorption efficiency can be increased in air having high relative humidity (specifically, air having a relative humidity of 20% or more). Therefore, it is possible to increase the moisture adsorption efficiency in a region where the relative humidity is high on the upstream side in the humidity controlling device 10, relative to the direction of air flow. The upper limit of the moisture adsorption amount Ad₂₀ is not particularly limited, but it is generally 80% by mass, preferably 60% by mass, and more preferably 40% by mass.

Here, the moisture adsorption isotherm in this specification is a graph plotting the amount of moisture adsorbed [% by mass] of the adsorbent when the relative humidity [%] in the air is changed in a moisture adsorption phenomenon, and serves as an index showing the ease of moisture adsorption by the adsorbent at each relative humidity in the air.

The moisture adsorption isotherm can be measured using a commercially available adsorption isotherm measuring device (BELSORP 18HTII manufactured by MicrotracBEL Corp.). Specifically, the measurement is performed after placing a target adsorbent in a measurement cell and degassing it under reduced pressure at 100° C. for approximately 5 hours. The measurement is performed at 20° C., and other conditions follow the conditions recommended for the adsorption isotherm measuring device.

In a moisture adsorption isotherm, the adsorbent has a difference Ad₈-Ad₁ between an amount of moisture adsorbed Ad₈ at a relative humidity of 8% and an amount of moisture adsorbed Ad₁ at a relative humidity of 1% (hereinafter abbreviated as “moisture adsorption amount difference Ad₈-Ad₁”) of 5% by mass or more, preferably 8% by mass or more, more preferably 10% by mass or more, and even more preferably 17% by mass or more. By controlling the moisture adsorption amount difference Ad₈-Ad₁ within such a range, the amount of moisture adsorbed increases between 1% and 8% relative humidity, thereby increasing the moisture adsorption efficiency in air having low relative humidity (specifically, air having a relative humidity of less than 20%). Therefore, it is possible to increase the moisture adsorption efficiency in a region where the relative humidity is low on the downstream side in the humidity controlling device 10, relative to the direction of air flow. On the other hand, in a regeneration process of the humidity controlling device 10, moisture is desorbed by heating the adsorbent contained in the adsorption portion 120. In the moisture adsorption isotherm, if the amount of moisture adsorbed does not decrease sufficiently in a state where the relative humidity is low, the regeneration process becomes difficult to proceed. Therefore, by setting the moisture adsorption amount difference Ad₈-Ad₁ within the above range, the amount of moisture adsorbed decreases in a state where the relative humidity is low, so that the regeneration process can proceed efficiently. It should be noted that the upper limit of the moisture adsorption amount difference Ad₈-Ad₁ is not particularly limited, but it is generally 50% by mass, preferably 30% by mass, and more preferably 20% by mass.

In a moisture adsorption isotherm, the adsorbent has a difference Ad₅-Ad₁ between an amount of moisture adsorbed Ad₈ at a relative humidity of 5% and an amount of moisture adsorbed Ad₁ at a relative humidity of 1% (hereinafter abbreviated as “moisture adsorption amount difference Ad₅-Ad₁”) of preferably 5% by mass or more, more preferably 6% by mass or more, and even more preferably 8% by mass or more. By controlling the moisture adsorption amount difference Ad₅-Ad₁ within such a range, the amount of moisture adsorbed increases between 1% and 5% relative humidity, thereby increasing the moisture adsorption efficiency in air having low relative humidity (specifically, air having a relative humidity of less than 20%). Further, by setting the moisture adsorption amount difference Ad₈-Ad₁ within the above range, the amount of moisture adsorbed decreases in a state where the relative humidity is low, so that the regeneration process can proceed efficiently. It should be noted that the upper limit of the moisture adsorption amount difference Ad₅-Ad₁ is not particularly limited, but it is generally 30% by mass, preferably 20% by mass, and more preferably 15% by mass.

In a moisture adsorption isotherm, the adsorbent has a difference Ad₅-Ad₃ between an amount of moisture adsorbed Ad₈ at a relative humidity of 5% and an amount of moisture adsorbed Ad₃ at a relative humidity of 3% (hereinafter abbreviated as “moisture adsorption amount difference Ad₈-Ad₃”) of preferably 2% by mass or more, and more preferably 3% by mass or more. By controlling the moisture adsorption amount difference Ad₅-Ad₃ within such a range, the amount of moisture adsorbed increases between 3% and 5% relative humidity, thereby increasing the moisture adsorption efficiency in air having low relative humidity (specifically, air having a relative humidity of less than 20%). Further, by setting the moisture adsorption amount difference Ad₅-Ad₃ within the above range, the amount of moisture adsorbed decreases in a state where the relative humidity is low, so that the regeneration process can proceed efficiently. It should be noted that the upper limit of the moisture adsorption amount difference Ad₈-Ad₃ is not particularly limited, but is generally 30% by mass, preferably 20% by mass, and more preferably 15% by mass.

Specific examples of the adsorbent are not particularly limited as long as they have the above characteristics, and examples thereof include X-type zeolite, Y-type zeolite, A-type zeolite, and MFI-type zeolite. These can be used alone or in combination of two or more.

In the Y-type zeolite, the moisture adsorption isotherm changes depending on the SiO₂/Al₂O₃ molar ratio. From the viewpoint of ensuring the above characteristics, the SiO₂/Al₂O₃ molar ratio of the Y-type zeolite is preferably 10 or less.

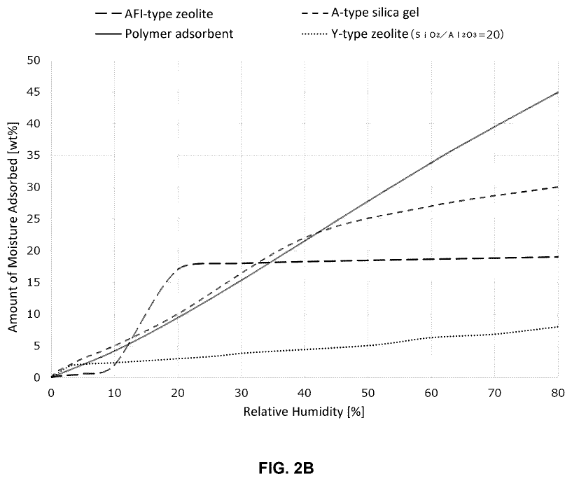

Here, moisture adsorption isotherms for several adsorbents are shown in FIGS. 2A and 2B. FIG. 2A is a moisture adsorption isotherm of an adsorbent usable in this disclosure, and FIG. 2B is a moisture adsorption isotherm of an adsorbent not usable in this disclosure.

As illustrated in FIG. 2A, in the moisture adsorption isotherm, the X-type zeolite has a moisture adsorption amount Ad₂₀ of 20% by mass or more, a moisture adsorption amount difference Ad₈-Ad₁ of 8% by mass, a moisture adsorption amount difference Ad₈-Ad₁ of 6% by mass, and a moisture adsorption amount difference Ad₈-Ad₃ of 3% by mass. In the moisture adsorption isotherm, the MFI-type zeolite has a moisture adsorption amount Ad₂₀ of 28% by mass or more, a moisture adsorption amount difference Ad₈-Ad₁ of 16% by mass, a moisture adsorption amount difference Ad₈-Ad₁ of 15% by mass, and a moisture adsorption amount difference Ad₈-Ad₃ of 6% by mass. In the moisture adsorption isotherm, the Y-type zeolite (SiO₂/Al₂O₃ molar ratio of 5) has a moisture adsorption amount Ad₂₀ of 31% by mass or more, a moisture adsorption amount difference Ad₈-Ad₁ of 23% by mass, a moisture adsorption amount difference Ad₈-Ad₁ of 22% by mass, and a moisture adsorption amount difference Ad₅-Ad₃ of 2% by mass. In the moisture adsorption isotherm, the Y-type zeolite (SiO₂/Al₂O₃ molar ratio of 10) has a moisture adsorption amount Ad₂₀ of 20% by mass or more, a moisture adsorption amount difference Ad₈-Ad₁ of 12% by mass, a moisture adsorption amount difference Ad₅-Ad₁ of 10% by mass, and a moisture adsorption amount difference Ad₅-Ad₃ of 4% by mass.

On the other hand, as illustrated in FIG. 2B, in the moisture adsorption isotherm, the AFI-type zeolite has a moisture adsorption amount Ad₂₀ of 17% by mass or more, a moisture adsorption amount difference Ad₈-Ad₁ of 1% by mass, a moisture adsorption amount difference Ad₈-Ad₁ of 1% by mass, and a moisture adsorption amount difference Ad₈-Ad₃ of 0% by mass. In the moisture adsorption isotherm, the A-type silica gel has a moisture adsorption amount Ad₂₀ of 10% by mass or more, a moisture adsorption amount difference Ad₈-Ad₁ of 3% by mass, a moisture adsorption amount difference Ad₈-Ad₁ of 2% by mass, and a moisture adsorption amount difference Ad₈-Ad₃ of 1% by mass. In the moisture adsorption isotherm, the polymer adsorbent has a moisture adsorption amount Ad₂₀ of 9% by mass or more, a moisture adsorption amount difference Ad₈-Ad₁ of 3% by mass, a moisture adsorption amount difference Ad₈-Ad₁ of 2% by mass, and a moisture adsorption amount difference Ad₈-Ad₃ of 1% by mass. In the moisture adsorption isotherm, the Y-type zeolite (SiO₂/Al₂O₃ molar ratio of 20) has a moisture adsorption amount Ad₂₀ of 3% by mass or more, a moisture adsorption amount difference Ad₈-Ad₁ of 2% by mass, a moisture adsorption amount difference Ad₈-Ad₁ of 2% by mass, and a moisture adsorption amount difference Ad₈-Ad₃ of 1% by mass.

It should be noted that the above-described moisture adsorption isotherms for the respective adsorbents are merely examples, and the values of the moisture adsorption amount Ad₂₀, the moisture adsorption amount difference Ad₈-Ad₁, the moisture adsorption amount difference Ad₈-Ad₁, and the moisture adsorption amount difference Ad₈-Ad₃ may vary depending on the source of each adsorbent or the like.

The base material portion 110 is not particularly limited, and those having various shapes can be used. The base material portion 110 can be, for example, in the form of a plate (sheet), a honeycomb, a pellet, or the like. When the base material portion 110 is in the form of the plate (sheet), it may have a structure folded into a pleated shape. Further, when the base material portion 110 is in the form of the plate or the pellet, the base material portion 110 provided with the adsorption portion 120 can be used by being filled into the humidity controlling device 10.

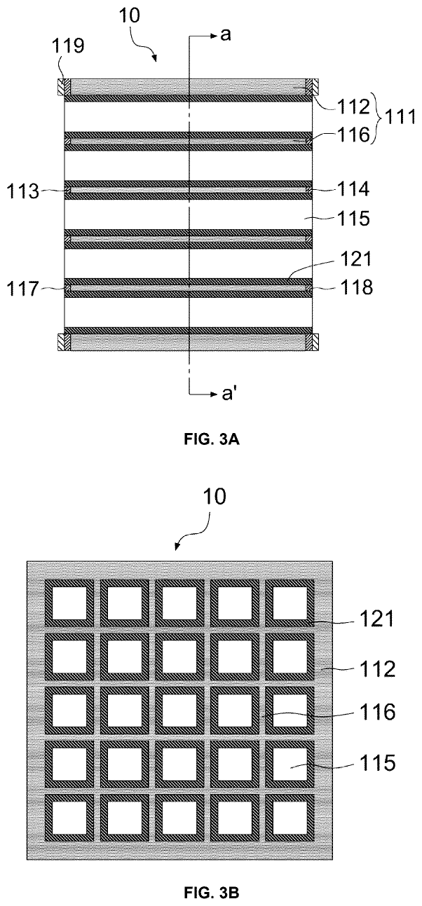

Here, FIG. 3A is a schematic cross-sectional view parallel to a flow direction of the humidity controlling device 10 when the base material portion 110 is a honeycomb structure, and FIG. 3B is a schematic cross-sectional view taken along the line a-a′ in the humidity controlling device of FIG. 3A.

As illustrated in FIGS. 3A and 3B, a honeycomb structure 111 has an outer peripheral wall 112 and partition walls 116 provided on an inner side of the outer peripheral wall 112, the partition walls 116 defining a plurality of cells 115, each of the cells 115 extending from a first end face 113 to a second end face 114 of the honeycomb structure 111 to form a flow path for air. An adsorbing layer 121 as the adsorption portion 120 is provided on a surface of each of the partition walls 116. Further, the adsorbing layer 121 may be provided on a surface of the outer peripheral wall 112 facing the cells 115. Furthermore, the honeycomb structure 111 can further include: a pair of electrodes 117,118; and terminals 119 connected to the pair of electrodes 117, 118, respectively.

### <Honeycomb Structure 111>

An outer shape of the honeycomb structure 111 is not particularly limited. For example, an outer shape of a cross section of the honeycomb structure 111 orthogonal to the flow path direction (extending direction of the cells 115) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 113 and second end face 114) have the same shape as the cross section. Also, when the cross section and the end faces are polygonal, the corners may be chamfered.

The shape of each cell 115 is not particularly limited, but it may be polygonal such as quadrangular, pentagonal, hexagonal, heptagonal, and octagonal, circular, or oval in the cross section of the honeycomb structure 111 orthogonal to the flow path direction. These shapes may be alone or in combination of two or more. Moreover, among these shapes, the quadrangle or the hexagon is preferable. By providing the cells 115 having such a shape, it is possible to reduce the pressure loss when the air flows.

The honeycomb structure 111 may be a honeycomb joined body that includes a plurality of honeycomb segments and joining layers that join outer peripheral side surfaces of the plurality of honeycomb segments together. The use of the honeycomb joined body can increase the total cross-sectional area of the cells 115, which is important for ensuring the flow rate (flow velocity) of the air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 112 and the partition walls 116. In addition to the role of joining the honeycomb segments to each other, the joining material can also be used as an outer peripheral coating material after joining the honeycomb segments.

From the viewpoints of ensuring the strength of the honeycomb structure 111, reducing pressure loss when air passes through the cells 115, ensuring the amount of functional material supported, and ensuring the contact area with the air flowing inside the cells 115, it is desirable to suitably combine a thickness of the partition wall 116, a cell density, and a cell pitch (or an opening ratio of the cells 115).

As used herein, the cell density refers a value obtained by dividing a number of cells by an area of one end face (first end face 113 or second end face 114) of the honeycomb structure 111 (the total area of the partition walls 116 and the cells 115 excluding the outer peripheral wall 112).

As used herein, the cell pitch refers to a value obtained by the following calculation. First, the area of one end face (first end face 113 or second end face 114) of the honeycomb structure 111 (the total area of the partition walls 116 and the cells 115 excluding the outer peripheral wall 112) is divided by the number of the cells to calculate an area per a cell. A square root of the area per a cell is then calculated, and this is determined to be the cell pitch.

As used herein, the opening ratio of the cells 115 refers a value obtained by dividing the total area of the cells 115 defined by the partition walls 116 by the area of one end face (first end face 113 or second end face 114) (the total area of the partition walls 116 and the cells 115 excluding the outer peripheral wall 112) in the cross section orthogonal to the flow path direction of the honeycomb structure 111. It should be noted that when calculating the opening ratio of the cells 115, the pair of electrodes 117, 118, and the adsorbing layer 121 are not taken into account.

In an embodiment that is advantageous from the viewpoint of supporting a sufficient amount of functional material, the thickness of the partition walls 116 is 0.300 mm or less, the cell density is 100 cells/cm² or less, and the cell pitch is 1.0 mm or more. In a preferred embodiment, the thickness of the partition walls 116 is 0.200 mm or less, the cell density is 70 cells/cm² or less, and the cell pitch is 1.2 mm or more. In a more preferred embodiment, the thickness of the partition walls 116 is 0.130 mm or less, the cell density is 65 cells/cm² or less, and the cell pitch is 1.3 mm or more.

From the viewpoints of ensuring the strength of the honeycomb structure 111 and maintaining lower electrical resistance, the lower limit of the thickness of the partition wall 116 is preferably 0.010 mm or more, more preferably 0.020 mm or more, and even more preferably 0.030 mm or more.

From the viewpoints of ensuring the strength of the honeycomb structure 111, maintaining lower electrical resistance, and increasing a surface area to facilitate reaction, adsorption, and separation, the lower limit of the cell density is 30 cells/cm² or more, and preferably 35 cells/cm² or more, and even more preferably 40 cells/cm² or more.

From the viewpoints of ensuring the strength of the honeycomb structure 111, maintaining lower electrical resistance and increasing a surface area to facilitate reaction, adsorption and separation, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 116 is 0.08 to 0.36 mm, the cell density is 2.54 to 140 cells/cm², and the opening ratio of the cells 115 is 0.70 or more. In a preferred embodiment, the thickness of the partition walls 116 is 0.09 to 0.35 mm, the cell density is 15 to 100 cells/cm², and the opening ratio of the cells 115 is 0.80 or more. In a more preferred embodiment, the thickness of the partition walls 116 is 0.14 to 0.30 mm, the cell density is 20 to 90 cells/cm², and the opening ratio of the cells 115 is 0.85 or more.

From the viewpoint of ensuring the strength of the honeycomb structure 111, the upper limit of the opening ratio of the cells 115 is preferably 0.94 or less, more preferably 0.92 or less, and even more preferably 0.90 or less.

Although the thickness of the outer peripheral wall 112 is not particularly limited, it is preferably determined based on the following considerations. First, from the viewpoint of reinforcing the honeycomb structure 111, the thickness of the outer peripheral wall 112 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 112 is preferably 1.0 mm or less, more preferably 0.5 mm, even more preferably 0.4 mm or less, and still more preferably 0.3 mm or less.

As used herein, the thickness of the outer peripheral wall 112 refers to a length from a boundary between the outer peripheral wall 112 and the outermost cell 115 or the partition wall 116 to a side surface of the honeycomb structure 111 in a normal line direction of the side surface in the cross section orthogonal to the flow path direction.

The length of the honeycomb structure 111 in the flow path direction and the cross-sectional area orthogonal to the flow path direction may be adjusted according to the required size of the humidity controlling device 10, and are not particularly limited. For example, when used in a compact humidity controlling device 10 while ensuring a predetermined function, the honeycomb structure 111 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm² or less.

The partition walls 116 forming the honeycomb structure 111 are preferably made of a material that can be heated by electric conduction, specifically made of a material having a PTC property. Further, the outer peripheral wall 112 may also be made of a material having a PTC property, as with the partition walls 116, as needed. By such a configuration, the adsorbing layer 121 can be directly heated by heat transfer from the heat-generating partition walls 116 (and optionally the outer peripheral wall 112). Further, the material having the PTC property has characteristics such that when the temperature increases to exceed the Curie point, the resistance value is sharply increased, making it difficult for electricity to flow. Therefore, when the temperature of the partition walls 116 (and the outer peripheral wall 112 if necessary) becomes high, the current flowing through them is limited, thereby suppressing excessive heat generation of the honeycomb structure 111. Therefore, it is possible to suppress thermal deterioration of the adsorbing layer 121 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271:2008.

From the viewpoints of creating a device that can be heated by electric conduction and have the PTC property, the outer peripheral wall 112 and the partition walls 116 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystal grains is not particularly limited, but it may generally be 99% by mass, and preferably 98% by mass.

In terms of reduction of the environmental load, it is desirable that the materials used for the outer peripheral wall 112 and the partition walls 116 are substantially free of lead (Pb). Specifically, the outer peripheral wall 112 and the partition walls 116 preferably have a Pb content of 0.01% by mass or less, and more preferably 0.001% by mass or less, and still more preferably 0% by mass. The lower Pb content can allow the air heated by contact with the heat-generating partition walls 116 to be safely applied to organisms such as humans, for example. In the outer peripheral wall 112 and the partition walls 116, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

The Curie point of the material making up the outer peripheral wall 112 and the partition walls 116 is preferably in a temperature range where the resistance value is twice or more the resistance at room temperature (25° C.). If the Curie point is in such a temperature range, the current flowing through the humidity controlling device 10 will be limited when the temperature of the humidity controlling device 10 becomes high, so that any excessive heat generation of the humidity controlling device 30 will be efficiently suppressed. Therefore, thermal deterioration of the adsorbing layer 121 caused by excessive heat generation can be suppressed.

In terms of efficiently heating the adsorbing layer 121, the material making up the outer peripheral wall 112 and the partition walls 116 preferably have a lower limit of a Curie point of 80° C. or more, more preferably 100° C. or more, even more preferably 110° C. or more, and still more preferably 125° C. or more. Further, in terms of safety as a component placed in the vehicle interior or near the vehicle interior, the upper limit of the Curie point is preferably 200° C. or more, more preferably 190° C. or more, even more preferably 180° C. or more, and still more preferably 150° C. or more.

The Curie point of the material making up the outer peripheral wall 112 and the partition walls 116 can be adjusted by the type and amount of shifter added. For example, the Curie point of barium titanate (BaTlO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### <A Pair of Electrodes 117, 118>

A pair of electrodes 117,118 may be provided on the first end face 113 and the second end face 114 of the honeycomb structure 111, respectively, as illustrated in FIG. 3A, although the positions of the electrodes 117, 118 are not limited thereto. Also, the pair of electrodes 117, 118 may be provided on the outer peripheral wall 112 parallel to the extending direction of the cells 115 of the honeycomb structure 111.

Applying of a voltage between the pair of electrodes 117, 118 allows the honeycomb structure 111 to generate heat by Joule heat.

The pair of electrodes 117, 118 may employ, for example, a metal or alloy containing at least one selected from Cu, Ag, Al, Ni and Si, although not particularly limited thereto. It is also possible to use an ohmic electrode capable of ohmic contact with the outer peripheral wall 112 and/or the partition walls 116 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 117, 118 may have a single-layer structure, or may have a laminated structure of two or more layers. When the pair of electrodes 117, 118 have the laminated structure of two or more layers, the materials of the respective layers may be of the same type or of different types.

The thickness of the pair of electrodes 117, 118 may be appropriately set according to the method for forming the pair of electrodes 117,118. The method for forming the pair of electrodes 117, 118 includes metal deposition methods such as sputtering, vapor deposition, electrolytic deposition, and chemical deposition. Alternatively, the pair of electrodes 117, 118 can be formed by applying an electrode paste and then baking it, or by thermal spraying. Furthermore, the pair of electrodes 117, 118 may be formed by joining metal sheets or alloy sheets.

Each of the thicknesses of the pair of electrodes 117, 118 is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### <Terminal 119>

The terminals 119 are connected to the pair of electrodes 117, 118, respectively, and provided on at least a part of the pair of electrodes 117, 118. The provision of the terminals 119 facilitates connection to an external power source. The terminals 119 are connected to a conductor wire connected to the external power source.

The terminals 119 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 119 are not particularly limited. For example, as shown in FIG. 3A, the terminals 119 can be provided on the whole of the pair of electrodes 117, 118 on the outer peripheral wall 112. Further, the terminals 119 may be provided on a part of the pair of electrodes 117, 118 on the outer peripheral wall 112, or may be provided so as to extend toward an outer side than the outer edge of each of the pair of electrodes 117, 118 on the outer peripheral wall 112. Further, the terminals 119 may be provided on a part of the pair of electrodes 117, 118 on the partition walls 116, or may be provided so as to block a part of the cells 115.

Furthermore, the thickness of the terminal 119 is not particularly limited, but it is, for example, 0.01 to 10 mm, typically 0.05 to 5 mm.

The method of connecting the terminals 119 to the pair of electrodes 117, 118 is not particularly limited as long as they are electrically connected. For example, they can be connected by diffusion bonding, a mechanical pressing mechanism, welding, or the like.

### <Adsorbing Layer 121>

The adsorbing layer 121 contains an adsorbent.

The adsorbing layer 121 can be provided on the surfaces of the partition walls 116 (in the case of the outermost cells 115, the partition walls 116 that define the outermost cells 115 and the outer peripheral wall 112). By thus providing the adsorbing layer 121, the moisture is easily adsorbed during the adsorption process, and the adsorbing layer 121 can be easily heated during the regeneration process, so that the function of the adsorbing layer 121 can be regenerated.

The adsorbing layer 121 may be capable of adsorbing carbon dioxide and/or volatile components in addition to the moisture. If the adsorbing layer 121 is capable of adsorbing carbon dioxide and/or volatile components in addition to moisture, air purification effects can be obtained.

The volatile components in the air in the vehicle interior or the like are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The adsorbing layer 121 can contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the adsorbing layer 121 may be determined according to the size of the cells 115, and is not particularly limited. For example, from the viewpoint of ensuring sufficient contact with air, the thickness of the adsorbing layer 121 is preferably 20 μm or more, more preferably 25 μm or more, and even more preferably 30 μm or more. On the other hand, from the viewpoint of suppressing separation of the adsorbing layer 121 from the partition walls 116 and the outer peripheral wall 112, the thickness of the adsorbing layer 121 is preferably 400 μm or less, more preferably 380 μm or less, and even more preferably 350 μm or less.

The thickness of the adsorbing layer 121 is measured using the following procedure. Any cross section of the honeycomb structure 111 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 111. The thickness of each adsorbing layer 121 visually recognized from the cross-sectional image is calculated by dividing the cross-sectional area by the length of the cells 115 in the flow path direction. This calculation is performed for all the adsorbing layers 121 visually recognized from the cross-sectional image, and an average value thereof is determined to be the thickness of the adsorbing layer 121.

From the viewpoint of exerting a desired function in the humidity controlling device 10, an amount of the adsorbing layer 121 is preferably 50 to 500 g/L, more preferably 100 to 400 g/L, and even more preferably 150 to 350 g/L, based on the volume of the honeycomb structure 111. It should be noted that the volume of the honeycomb structure 111 is a value determined by the external dimensions of the honeycomb structure 111.

### <Method for Producing Humidity Controlling Device>

The method for producing the humidity controlling device 10 according to the embodiment of this disclosure is not particularly limited, and it can be performed according to a known method. Hereinafter, the method for producing the humidity controlling device 10 that uses the honeycomb structure 111 as the base material portion 110 will be illustratively described.

A method for producing the honeycomb structure 111 forming the humidity controlling device 10 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 111 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the honeycomb structure 111 can be densified. Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 111.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a honeycomb structure 111 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost. A firing furnace used in the firing step and the degreasing step is not particularly limited, but it may be an electric furnace, a gas furnace, or the like.

On the honeycomb structure 111 thus obtained, the pair of electrodes 117, 118 are formed. The pair of electrodes 117, 118 can be formed by metal deposition methods such as sputtering, vapor deposition, electrolytic deposition, and chemical deposition. Further, the pair of electrodes 117, 118 can also be formed by applying an electrode paste and then baking it. Furthermore, the pair of electrodes 117, 118 can also be formed by thermal spraying. The pair of electrodes 117, 118 may be composed of a single layer, but may also be composed of a plurality of electrode layers having different compositions. A typical method for forming the pair of electrodes 117, 118 will be described below.

First, an electrode slurry containing an electrode material, an organic binder, and a dispersion medium is prepared, and the first end face 113 or the second end face 114 of the honeycomb structure 111 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 111 is removed by blowing and wiping. The slurry can be then dried to form the pair of electrodes 117, 118 on the first end face 113 or the second end face 114 of the honeycomb structure 111. The drying can be performed while heating the honeycomb structure 111 to a temperature of about 120 to 600° C., for example. Although a series of steps of coating, slurry removal, and drying may be performed only once, the steps can be repeated multiple times to provide the pair of electrodes 117, 118 having desired thicknesses.

The terminals 119 are then provided at predetermined positions of the pair of electrodes 117, 118, and the pair of electrodes 117, 118 and the terminals 119 are connected to each other. As a method of connecting the pair of electrodes 117, 118 to the terminals 119, the method described above can be used.

It should be noted that the terminals 119 may be disposed after forming an adsorbing layer 121 described below.

The adsorbing layer 121 is then formed on the surfaces of the partition walls 116 and the like of the honeycomb structure 111.

Although the method for forming the adsorbing layer 121 is not particularly limited, it can be formed, for example, by the following steps. The honeycomb structure 111 is immersed in a slurry containing an adsorbent, an organic binder, and a dispersion medium for a predetermined period of time, and an excess slurry on the end faces and the outer periphery of the honeycomb structure 111 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 121 on the surfaces of the partition walls 116 and the like. The drying can be performed while heating the honeycomb structure 111 to a temperature of about 120 to 600° C., for example. Although a series of steps of immersion, slurry removal, and drying may be performed only once, the steps can be repeated multiple times to provide the adsorbing layer 121 having the desired thickness on the surfaces of the partition walls 116 and the like.

### (2. Humidity Controlling System)

A humidity controlling system according to an embodiment of this disclosure includes a flow path through which air can flow, and the humidity controlling device 10 provided in the flow path.

The humidity controlling system according to the embodiment of this disclosure is not particularly limited as long as it has the above structures, and can be applied to existing humidity controlling systems except for using the humidity controlling device 10. Hereinafter, an example of humidity controlling systems according to embodiments of this disclosure is described.

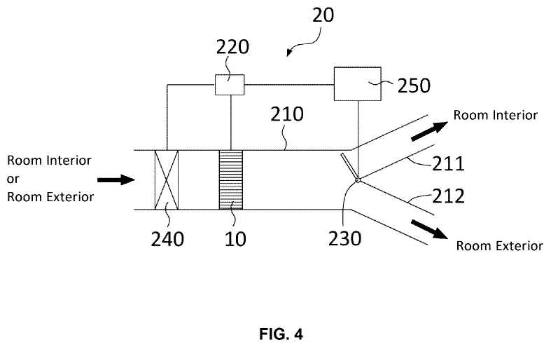

FIG. 4 is an overall schematic configuration view of a humidity controlling system according to an embodiment of the present disclosure.

As illustrated in FIG. 4, a humidity controlling system 20 according to an embodiment of this application include an air conditioning duct 210; a humidity controlling device 10; a power source 220; a valve 230; a ventilation fan 240.

### <Air Conditioning Duct 210>

The air conditioning duct 210 is a flow path through which air can flow, and forms the flow path through which air can flow. The upstream side of the air conditioning duct 210 is connected to the room interior or room exterior (particularly for vehicles, a vehicle interior or an outside air introduction port). The air conditioning duct 210 allows the air from the room interior or the room exterior to flow in, and also allows the air that has passed through the humidity controlling device 10 to flow in the room interior or flow out to the room exterior. Therefore, on a downstream side of the humidity conditioning device 10, the air conditioning duct 210 preferably branches into a first flow path 211 that allows the air to flow into the room interior, and a second flow path 212 that allows the air to be discharged to the room exterior.

The air conditioning duct 210 may include a valve 230 that can switch the flow of the air between the first flow 211 and the second flow path 212. The valve 230 is not particularly limited as long as it is electrically driven and has the function of switching the flow path, and a solenoid valve, an electric valve, and the like can be used. For example, the valve 230 includes an opening/closing door supported by a rotating shaft and an actuator such as a motor that rotates the rotating shaft. The actuator can be configured to be controllable by the control unit 250.

### <Humidity Controlling Device 10>

The humidity controlling device 10 is provided in the air conditioning duct 210. The number of humidity controlling devices 10 provided in the air conditioning duct 210 may be one or more than one. When more than one humidity controlling devices 10 are provided, they may be arranged in parallel to or in series with the flow of the air flowing through the air conditioning duct 210.

### <Power Source 220>

The power source 220 is for applying a voltage to the humidity controlling device 10 (in particular, the pair of electrodes 117,118). The power source 220 is electrically connected to a control unit 250, and adjusts the state of the voltage applied to the pair of electrodes 117, 118 according to instructions from the control unit 250.

The power source 220 is not particularly limited, and a battery or the like can be used.

### <Ventilation Fan 240>

The ventilation fan 240 is a device for allowing the air from the room interior or the room exterior to flow into the humidity controlling device 10, and is provided in the air conditioning duct 210. The position of the ventilation fan 240 is not limited, but it may be on the upstream side of the humidity controlling device 10, for example, as illustrated in FIG. 4, or on the downstream side of the humidity controlling device 10.

The ventilation fan 240 is electrically connected to the control unit 250 and can control the flow velocity of the air by adjusting the rotation speed according to instructions from the control unit 250.

### <Control Unit 250>

The control unit 250 is electrically connected to the power source 220, the valve 230, the ventilation fan 240, and the like, and it can control these members. The control unit 250 can control the power source 220, thereby adjusting the heating state of the honeycomb structure 111 by controlling a voltage applying state to the pair of electrodes 117, 118 of the humidity controlling device 10. Further, the control unit 250 can also control the valve 230 so that the air flows through the first flow 211 or the second flow path 212. Furthermore, the control unit 250 can adjust the rotation speed of the ventilation fan 240, thereby controlling the flow velocity of the air flowing through the air conditioning duct 210.

The control unit 250 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

The control unit 250 is capable of performing an adsorption process for turning off the applied voltage from the power source 220 and switching the valve 230 so that the air flowing through the air conditioning duct 210 passes through the first flow path 211, and a regeneration process for turning on the applied voltage from the power source 220 and switching the valve 230 so that the air flowing through the air conditioning duct 210 passes through the second flow path 212. Such a control allows the adsorption process and the regeneration process to be easily carried out.

In the adsorption process, the moisture in the air flowing from the room interior or the room exterior is adsorbed by the above control in the control unit 250. At this time, the honeycomb structure 111 of the humidity controlling device 10 is not heated. Specifically, the air from the room interior or the room exterior flows in the humidity controlling device 10 through the air conditioning duct 210, and the moisture contained in the air is adsorbed. The air that has captured the moisture is returned to the room interior through the first flow path 211.

In the regeneration mode, the adsorption portion 120 (absorbing layer 121) of the humidity controlling device 10 is regenerated by the above control in the control unit 250. At this time, the honeycomb structure 111 of the humidity controlling device 10 is heated. Specifically, the air from the room interior or room exterior allows the moisture that has been adsorbed to the adsorption portion 120 (adsorbing layer 121) to be desorbed while the air flows in the humidity controlling device 10 through the air conditioning duct 210 and passes through the humidity controlling device 10. Then, the air containing the moisture is discharged to the room exterior through the second flow path 212.

When the humidity controlling system 20 is for vehicles, from the viewpoint of stably performing the above control, it is desirable that the humidity controlling device 10 be placed at a position close to the vehicle interior. Therefore, from the viewpoint of preventing electric shock and the like, it is preferable that the driving voltage of the humidity controlling device 10 is 60V or less. Since the honeycomb structure 111 used in the humidity controlling device 10 has a low electrical resistance at room temperature, the honeycomb structure 111 can be heated at the low driving voltage. It should be noted that the lower limit of the driving voltage is not particularly limited, but it may preferably be 10 V or more. If the driving voltage is less than 10V, the current during heating the honeycomb structure 111 becomes large, so that the conductor wire should be thick.

### Examples

Hereinafter, the present disclosure will be more specifically described with reference to Examples, but the present disclosure is not limited to these Examples.

### <Production of Humidity Controlling Device>

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.

Shape of cross section and end face of honeycomb structure orthogonal to flow path direction: quadrangular;

Shape of cross section of cells orthogonal to flow path direction:
quadrangular;
   Thickness of partition walls: 0.100 mm;
   Thickness of outer peripheral wall: 0.2 mm;
   Cell density: 80 cells/cm²;
   Cell pitch: 1.1 mm;
   Cross-sectional area of honeycomb structure orthogonal to extending direction of flow path: 6000 mm²;
   Length of honeycomb structure in extending direction of flow path: 10 mm;
   Volume resistivity of materials comprised of outer peripheral wall and partition wall at 25° C.: 15 Ω·cm; and
   Curie point of material making up outer peripheral wall and partition wall: 110° C.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The pair of electrodes were formed on both end faces (first end face and second end face) of the resulting honeycomb structure. First, an electrode slurry containing aluminum (electrode material), ethyl cellulose and diethylene glycol monobutyl ether (organic binder) was prepared and applied to the first end face, and the electrode slurry was then dried to form an electrode on the first end face. Using the same electrode slurry, an electrode was formed on the second end face by applying the electrode slurry to the second end face and drying it.

Next, using X-type zeolite (Example 1), Y-type zeolite (SiO₂/A₂O₃ molar ratio of 10) (Example 2), MFI-type zeolite (Example 3), Y-type zeolite (SiO₂/Al₂O₃ molar ratio of 5) (Example 4), and A-type silica gel (Comparative Example 1) as adsorbents, each honeycomb structure having a pair of electrodes formed thereon was immersed in a slurry containing each adsorbent, an organic binder, and water, and the slurry adhering to unnecessary portions (such as the outer periphery) was removed by blowing and wiping, and then the honeycomb structure was dried at a temperature of about 550° C. to form an adsorbing layer having a thickness of 150 μm on the surfaces of the partition walls and the surface of the outer peripheral wall facing the cells.

The humidity controlling device obtained as described above was placed in the air conditioning duct to construct the humidity controlling system illustrated in FIG. 4. The following evaluations were performed on the humidity controlling system.

### <Absorption (Moisture Adsorbing) Performance>

The humidity controlling system was subjected to the regeneration process, followed by the adsorption process. The regeneration process was performed by starting the ventilation fan and allowing the air at a temperature of 25° C. and at relative humidity of 40% to flow at a flow rate of 25 L/min through the air conditioning duct while applying a voltage of 12 V from a direct current power source to the humidity controlling device for 3 minutes. The adsorption process was performed by allowing the air under the same conditions to flow in the air conditioning duct for 3 minutes at a flow rate of 380 L/min, without applying a voltage to the humidity controlling device. In the adsorption process, the absolute humidity [g/m³] at the inlet and outlet of the humidity controlling device was measured, and an amount of moisture adsorbed [g] was calculated by the following equation:

Amount of moisture adsorbed [g]=(absolute humidity at inlet of humidity controlling device [g/m³]−absolute humidity at outlet of humidity controlling device [g/m³])×flow rate [m³/min]×duration time for adsorption process [min].

In addition, if the amount of moisture adsorbed is 3.0 g or more, the adsorption performance can be determined to be good.

### <Regeneration (Moisture Desorbing) Performance>

The humidity controlling system was subjected to the adsorption process, followed by the regeneration mode. The adsorption process was performed by starting the ventilator and allowing the air at a temperature of 25° C. and at relative humidity of 40% to flow at a flow rate of 380 L/min through the air conditioning duct for 3 minutes, without applying a voltage to the humidity controlling device. The regeneration process was performing by applying a voltage of 12 V from a DC power source device to the conditioning device for 3 minutes while allowing the air under the same conditions to flow through the air conditioning duct at a flow rate of 25 L/min. In the regeneration process, the absolute humidity [g/m³] at the inlet and outlet of the air humidity controlling device was measured, and an amount of moisture desorbed [g] was calculated by the following equation:

Amount of moisture desorbed [g]=(absolute humidity at outlet of humidity controlling device [g/m³]-absolute humidity at inlet of humidity controlling device [g/m³])×flow rate [m³/min]×duration time for regeneration process [min]

In addition, If the amount of moisture desorbed is 1.0 g or more, the regeneration performance can be determined to be good.

The results of the above evaluations are shown in Table 1.

TABLE 1

| | Amount of | Difference between amounts | | | Amount of | Amount of |
|---|---|---|---|---|---|---|
| | moisture | of moisture adsorbed | | | moisture | moisture |
| | adsorbed Ad₂₀ | [% by mass] | | | adsorbed | desorbed |
| | [% by mass] | Ad [symbol] − Ad₁ | Ad₅ − Ad₁ | Ad₅ − Ad₃ | [g] | [g] |
| Example 1 | 20 | 8 | 5 | 3 | 3.0 | 1.2 |
| Example 2 | 22 | 10 | 7 | 2 | 3.3 | 1.5 |
| Example 3 | 28 | 17 | 17 | 3 | 4.2 | 2.6 |
| Example 4 | 31 | 21 | 20 | 2 | 4.7 | 3.2 |
| Comp. 1 | 10 | 3 | 2 | 1 | 1.5 | 0.5 |

[symbol]

indicates data missing or illegible when filed

As shown in Table 1, the humidity controlling devices according to Examples 1 to 4 had a larger amount of moisture adsorbed than the humidity controlling device according to Comparative Example 1. This would be because the moisture could be efficiently adsorbed not only in the upstream adsorption layer but also in the downstream adsorption layer relative to the air flow direction. In addition, the humidity controlling devices according to Examples 1 to 4 also had a larger amount of moisture desorbed than the humidity controlling device according to Comparative Example 1, and the regeneration process could be performed efficiently.

As can be seen from the above results, according to this disclosure, it is possible to provide a humidity controlling device and a humidity controlling system that can efficiently adsorb moisture in the air regardless of the humidity in the air.

### DESCRIPTION OF REFERENCE NUMERALS

10 humidity controlling device
110 base material portion
111 honeycomb structure
112 outer peripheral wall
113 first end face
114 second end face
115 cell
116 partition wall
117, 118 electrode
119 terminal
120 adsorption portion
121 adsorbing layer
20 humidity controlling system
210 air conditioning duct
211 first flow path
212 second flow path
220 power source
230 valve
240 ventilation fan
250 control unit

1. A humidity controlling device comprising:
a base material portion; and
an adsorption portion provided on a surface of the base material portion, the adsorption portion comprising an adsorbent configured to adsorb and desorb moisture,
wherein the adsorbent has an amount of moisture adsorbed Ad₂₀ of 15% by mass or more at a relative humidity of 20% or more, and a difference Ad₈-Ad₁ of 5% by mass or more, the difference being between an amount of moisture adsorbed Ad₈ at a relative humidity of 8% and an amount of moisture adsorbed Ad₁ at a relative humidity of 1%, in a moisture adsorption isotherm.

2. The humidity controlling device according to claim 1, wherein the amount of moisture adsorbed Ad₂₀ at a relative humidity of 20% or more is 20% by mass or more in the moisture adsorption isotherm.

3. The humidity controlling device according to claim 1, wherein the amount of moisture adsorbed Ad₂₀ at a relative humidity of 20% or more is 23% by mass or more in the moisture adsorption isotherm.

4. The humidity controlling device according to claim 1, wherein the amount of moisture adsorbed Ad₂₀ at a relative humidity of 20% or more is 25% by mass or more in the moisture adsorption isotherm.

5. The humidity controlling device according to claim 1, wherein the difference Ad₈-Ad₁ between the amount of moisture adsorbed Ad₈ at a relative humidity of 8% and the amount of moisture adsorbed Ad₁ at a relative humidity of 1% is 8% by mass or more in the moisture adsorption isotherm.

6. The humidity controlling device according to claim 1, wherein the difference Ad₈-Ad₁ between the amount of moisture adsorbed Ad₈ at a relative humidity of 8% and the amount of moisture adsorbed Ad₁ at a relative humidity of 1% is 10% by mass or more in the moisture adsorption isotherm.

7. The humidity controlling device according to claim 1, wherein the difference Ad₈-Ad₁ between the amount of moisture adsorbed Ad₈ at a relative humidity of 8% and the amount of moisture adsorbed Ad₁ at a relative humidity of 1% is 17% by mass or more in the moisture adsorption isotherm.

8. The humidity controlling device according to claim 1, wherein the difference Ad₈-Ad₁ between the amount of moisture adsorbed Ad₈ at a relative humidity of 5% and the amount of moisture adsorbed Ad₁ at a relative humidity of 1% is 5% by mass or more in the moisture adsorption isotherm.

9. The humidity controlling device according to claim 1, wherein the difference Ad₈-Ad₃ between the amount of moisture adsorbed Ad₈ at a relative humidity of 5% and the amount of moisture adsorbed Ad₃ at a relative humidity of 3% is 2% by mass or more in the moisture adsorption isotherm.

10. The humidity controlling device according to claim 1, wherein the adsorbent is at least one selected from the group consisting of X-type zeolite, Y-type zeolite, A-type zeolite, and MFI-type zeolite.

11. The humidity controlling device according to claim 1, wherein the adsorbent is a Y-type zeolite having a SiO₂/Al₂O₃ molar ratio of 10 or less.

12. The humidity controlling device according to claim 1, wherein the base material portion is a honeycomb structure having an outer peripheral wall and partition walls provided on an inner side of the outer peripheral wall, the partition walls defining a plurality of cells, each of the cells extending from a first end face to a second end face of the honeycomb structure to form a flow path for air,
and wherein the adsorption portion is an adsorbing layer provided on a surface of each of the partition walls.

13. The humidity controlling device according to claim 12, further comprising a pair of electrodes provided on the first end face and the second end face of the honeycomb structure, or on the outer peripheral wall parallel to an extending direction of the cells of the honeycomb structure.

14. The humidity controlling device according to claim 12, wherein at least the partition walls of the honeycomb structure are made of a material having a positive temperature coefficient (PTC) property.

15. A humidity controlling system comprising:
a flow path through which air can flow; and
the humidity controlling device according to claim 1 provided in the flow path.
